(19) United States
(12) Patent Application Publication
(10) Pub. No.: US 2023/0281149 A1
(43) Pub. Date: Sep. 7, 2023

(54) BUS CONTROL METHOD

(71) Applicant: LAPIS TECHNOLOGY CO., LTD., KANAGAWA (JP)

(72) Inventor: MASATO YAMAZAKI, KANAGAWA (JP)

(21) Appl. No.: 18/116,898

(22) Filed: Mar. 3, 2023

(30) Foreign Application Priority Data
Mar. 4, 2022 (JP) 2022-033893

(51) Int. Cl. G06F 13/42

(52) U.S. Cl. CPC G06F 13/4247

(57) ABSTRACT

A bus control method for communication between a plurality of communication devices, the bus control method including: a first communication device and a second communication device communicating via a bus structured with a first connection port and a second connection port; the first communication device sending a first send request signal on the bus to the second communication device via the first connection port; the second communication device sending a second send request signal on the bus to the first communication device via the second connection port; and on the basis of the first send request signal and the second send request signal, performing control such that the bus accepts data from one connection port of the first connection port and the second connection port, wherein the first send request signal and the second send request signal are respectively different signals.

### CROSS-REFERENCE TO RELATED APPLICATION

This application is based on and claims priority under 35 USC 119 from Japanese Patent Application No. 2022-033893 filed on Mar. 4, 2022, the disclosure of which is incorporated by reference herein.

### BACKGROUND

### Technical Field

The present disclosure relates to a bus control method.

### Related Art

Heretofore there have been technologies, relating to monitoring states of cells, that use a communication system with a daisy-chain connection in which units of plural cells are connected in series.

For example, a technology (see Japanese Patent Application Laid-Open (JP-A) No. 2015-076890) relates to a daisy-chain communication bus and protocol. In this technology, a communication circuit transfers cell state data in one direction on a bidirectional data path and through a first connection node to a circuit at a first side. In response to an indication that the bidirectional data path is incomplete, the communication circuit transfers cell state data in the other direction on the bidirectional data path and through a second connection node to a circuit at a second side.

In conventional technology, an example of a battery management system is disclosed in which plural connection circuits mounted at battery cells are connected in a daisy chain to enable bidirectional communications and are managed by a battery manager. At usual times, the battery manager conducts communications in one direction. When an abnormality such as a disconnection between cells or the like occurs, the battery manager conducts communications in the opposite direction. Thus, management of the battery cells is possible even when an abnormality occurs.

In the conventional technology, communications are conducted using a path to one side, and when communication is not possible, are switched to communications using a path to the other side. Reasonably, although the paths at both sides may be used, a communication system that uses one of the paths is assumed. Thus, no consideration is given to communication control when the paths in both directions are being used at the same time.

### SUMMARY

An object of the disclosed technology is to provide a bus control method that conducts communication control with bus arbitration and enables communication using paths in both directions of a daisy-chain connection at the same time.

The bus control method according to the present disclosure is a bus control method for communication between plural communication devices, the bus control method including: a first communication device and a second communication device communicating via a bus structured with a first connection port and a second connection port; the first communication device sending a first send request signal on the bus to the second communication device via the first connection port; the second communication device sending a second send request signal on the bus to the first communication device via the second connection port; and on the basis of the first send request signal and the second send request signal, performing control such that the bus accepts data from one connection port of the first connection port and the second connection port, wherein the first send request signal and the second send request signal are respectively different signals.

The bus control method of the present disclosure provides effects of conducting communication control with bus arbitration and enabling communication using paths in both directions of a daisy-chain connection at the same time.

### BRIEF DESCRIPTION OF THE DRAWINGS

Exemplary embodiments of the present disclosure will be described in detail based on the following figures, wherein:

FIG. 1 is a diagram showing structures of a battery monitoring system;

FIG. 2 is a diagram showing a configuration for bus arbitration between connection ports;

FIG. 3 is a diagram showing the bus arbitration for each of sending modes;

FIG. 4 is a diagram showing an example of a chronology of communications when a communications interface circuit sends simultaneous requests and an output command is received at any of battery pack units from both directions;

FIG. 5 is a diagram showing an example of using communication path dialog commands for abnormality detection and abnormality site detection;

FIG. 6A is a timing chart for when a send request is sent only at a first connection port 21A;

FIG. 6B is a timing chart for when the send request is sent only at the first connection port 21A;

FIG. 7A is a timing chart for when a send request is sent only at a second connection port 21B;

FIG. 7B is a timing chart for when the send request is sent only at the second connection port 21B;

FIG. 8A is a timing chart for when send requests are simultaneously sent at the first connection port 21A and the second connection port 21B;

FIG. 8B is a timing chart for when the send requests are simultaneously sent at the first connection port 21A and the second connection port 21B;

FIG. 8C is a timing chart for when the send requests are simultaneously sent at the first connection port 21A and the second connection port 21B;

FIG. 9 shows a situation when a slave makes a Req request first, bus access is granted to the slave, and data is transferred from the slave to a master;

FIG. 10 shows a situation when the master and the slave make Req requests at the same time, bus access is granted to the master, and data is transferred from the master to the slave; and

FIG. 11 shows a situation when the master makes a Req request first, bus access is granted to the master, and data is transferred from the master to the slave.

### DETAILED DESCRIPTION

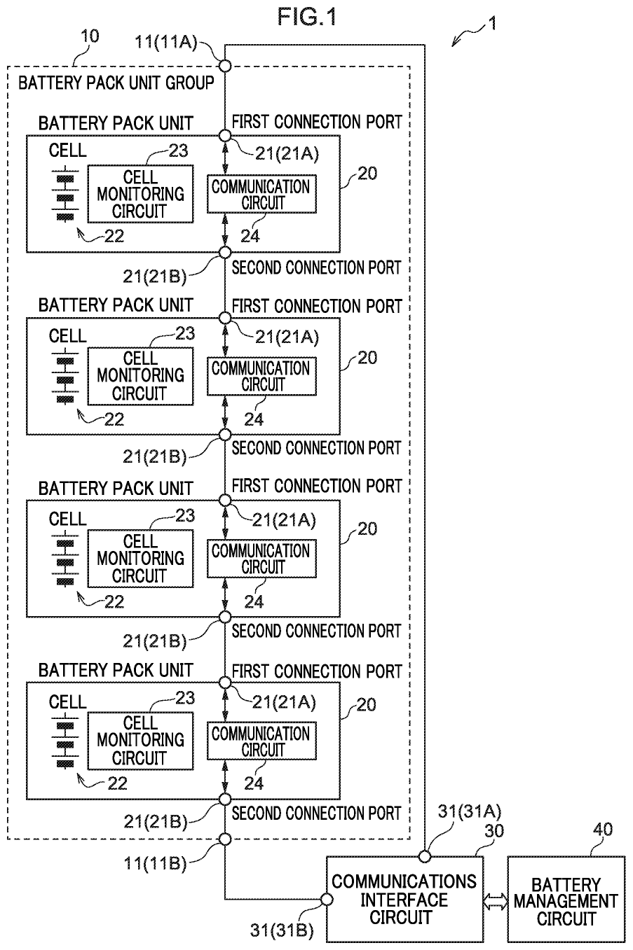

Below, an exemplary embodiment of the present disclosure (below referred to as the present exemplary embodiment) is described with reference to the drawings. FIG. 1 is a diagram showing structures of a battery monitoring system. A battery monitoring system 1 is equipped with a battery pack unit group 10 formed of plural battery pack units 20, a communications interface circuit 30, and a battery management circuit 40. The plural battery pack units 20 of the battery pack unit group 10 are daisy-chain connected in series through connection ports. The communications interface circuit 30 is arranged so as to transfer monitoring data between the battery pack unit group 10 and the battery management circuit 40. The battery management circuit 40 is configured so as to control the battery pack units 20 in response to monitoring data of respective cells in the battery pack units 20.

Each battery pack unit 20 is equipped with a cell monitoring circuit 23 that monitors a plural number of cells 22, a communication circuit 24 for transferring monitored monitoring data out of the battery pack unit 20, and connection ports 21 for sending communication data including the monitoring data. The connection ports include a first connection port 21A at a master side in the daisy-chain connection and a second connection port 21B at a slave side in the daisy-chain connection. The first connection port 21A and second connection port 21B may be recited simply as connection ports in relation to matters discussing both. The battery pack unit 20 and each neighboring battery pack unit 20 conduct communications (between the battery pack units) via a bus structured by the first connection port 21A, the neighboring second connection port 21B and the communication circuits 24. The battery pack units 20 are an example of communication devices according to the present disclosure (a first communication device and a second communication device), and each communication circuit 24 is an example of a communication section.

A group first connection port 11A of the battery pack unit group 10 is connected to a third connection port 31A of the communications interface circuit 30, and a group second connection port 11B is connected to a fourth connection port 31B of the communications interface circuit 30. The group first connection port 11A may be the first connection port 21A of the battery pack unit 20 at one end of the daisy-chain connections. The group second connection port 11B may be the second connection port 21B of the battery pack unit 20 at the other end of the connections.

—Configuration Between Connection Ports—

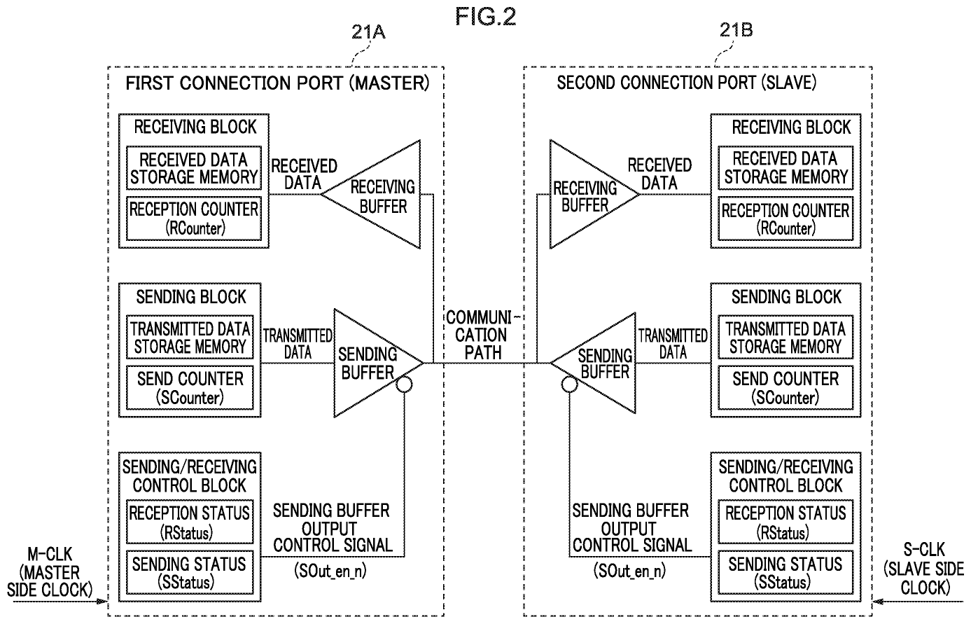

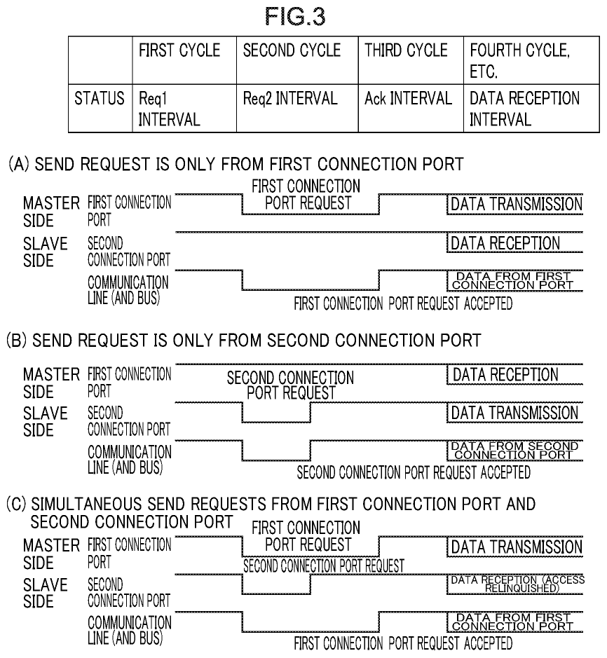

Bus arbitration between the first connection port 21A and the second connection port 21B is described. Below, an example is described in which bus arbitration is configured with an AND bus. FIG. 2 is a diagram showing a configuration for bus arbitration between the connection ports. FIG. 3 is a diagram showing the bus arbitration for respective sending modes.

A communication path in FIG. 2 (including each communication circuit 24) serves as an AND bus. As shown in FIG. 2, data communications between the connection ports are configured such that received data is received by a receiving buffer and transmitted data is sent by a sending buffer. Each receiving block stores received data in a received data storage memory, and counts and clears a reception counter value at a reception counter. Each sending block sends transmitted data stored in a transmitted data storage memory, and counts and clears a send counter value at a send counter. A sending/receiving control block manages a reception status and a sending status. A sending buffer output control signal (SOut_en_n) is set to “Active” when the sending status (SStatus) is “Req1”, “Req2” or “Send”.

—Bus Arbitration According to the Present Exemplary Embodiment—

When the connection between the first connection port 21A and the second connection port 21B is configured as an AND bus, output is high at a time of non-communication and bus access for the AND bus is set to “Free”. When the bus access status for the AND bus is “Free” for both the first connection port 21A and the second connection port 21B, the communication circuits 24 may output request signals requesting bus access.

(A) in FIG. 3 shows a situation in which a send request signal (below denoted simply as a send request) is sent only by the first connection port 21A, (B) shows a situation in which a send request is sent only by the second connection port 21B, and (C) shows a situation in which send requests are sent at the same time by both the first connection port 21A and the second connection port 21B, and the request from the first connection port 21A is accepted. In the battery monitoring system 1 according to the present exemplary embodiment, bus arbitration is employed in situation (C).

When the communication circuit 24 at the first connection port 21A attempts to start communication using the first connection port 21A, the communication circuit 24 drives the first connection port 21A low for two cycles (a first cycle and a second cycle) to request bus access. When the second cycle is monitored as being Low, bus access to the AND bus is reserved and, starting from a subsequent cycle (a third cycle), transmitted data is sent from the first connection port 21A.

When the communication circuit 24 at the second connection port 21B attempts to start communication using the second connection port 21B, the communication circuit 24 drives the second connection port 21B low for one cycle of the data cycle (a first cycle) to request bus access. When the second cycle is monitored as being High, bus access to the AND bus is reserved and, starting from a subsequent cycle (a third cycle), transmitted data is sent from the second connection port 21B.

At both the first connection port 21A and the second connection port 21B, when an output of transmitted data ends and communication is completed, the communication circuits 24 release bus access for the AND bus, switching to the High state of non-communication.

In situation (A), a send request is sent only from the communication circuit 24 at the first connection port 21A, the first connection port 21A is Low for two cycles, the request is accepted, and the communication line (the AND bus) receives data from the first connection port 21A. In situation (B), a send request is sent only from the communication circuit 24 at the second connection port 21B, the second connection port 21B is Low for one cycle, the request is accepted, and the communication line (the AND bus) receives data from the second connection port 21B.

In situation (C), when send requests are sent from the respective communication circuits 24 at the first connection port 21A and second connection port 21B at the same time, communication from the connection port sending the request from one of the communication circuits 24 is accepted and data reception according to the request from the other communication circuit 24 is abandoned. In the example in situation (C), the request from the first connection port 21A, which serves as a master side, is accepted. Therefore, data reception from the second connection port 21B (a slave side) is abandoned and the communication line (the AND bus) accepts data from the first connection port 21A. In this bus control method as described above, when a send request is received, each communication circuit 24 at the bus monitors states of the bus at a predetermined interval. In response to a change in state of the bus in the predetermined interval, the communication circuits 24 decide which of the battery pack units the bus accepts the request from.

In the bus arbitration according to the present exemplary embodiment, a sampling timing for received data is generated from a received request signal (reception clock regeneration). Because frequencies and phases generated by oscillators of the respective battery pack units 20 differ, a sampling timing for received data is generated from edge information of data that is received (the request signal). After the fall of a request signal is detected, an internal counter starts. After the fall of the request signal is detected, the internal counter value is retained, the counter is cleared and counting is started. When the second connection port 21B is receiving, because the request signal from the first connection port 21A corresponds to two cycles, the second connection port 21B latches received data each time the value of the counter is at quarter of the retained counter value and clears the counter each time the value is at half the retained count value. When the first connection port 21A is receiving, because the request signal from the second connection port corresponds to one cycle, the first connection port 21A latches received data each time the value of the counter is at half of the retained counter value and clears the counter each time the value is at the retained count value. The request signal from the first connection port 21A and the request signal from the second connection port 21B are signals with different lengths. The request signal from the first connection port 21A is two cycles, which is longer than the one-cycle request signal from the second connection port 21B. The period of the request signal from the second connection port 21B is half the length of the two-cycle period of the request signal from the first connection port 21A. Note that the cycle lengths are not limited to two cycles and one cycle. Supplementary descriptions of details of the bus arbitration timing charts for situations (A) to (C) are given below, after descriptions of principal details of the present exemplary embodiment.

—Flow of Communication Processing—

A flow of communication processing in the battery monitoring system 1 when send requests (“output commands” below) are sent simultaneously is described. The communications interface circuit 30 receives a request, in a command from the battery management circuit 40, to command outputs of monitoring data from the cells. In the battery monitoring system 1, an output command is sent simultaneously from the third connection port 31A and fourth connection port 31B of the communications interface circuit 30 to the bidirectional connection ports of the battery pack unit group, the group first connection port 11A and the group second connection port 11B. In the battery monitoring system 1, communication control is conducted such that the output command is propagated to all of the plural battery pack units 20, and communication data outputted from each of the plural battery pack units 20 is outputted from the bidirectional connection ports.

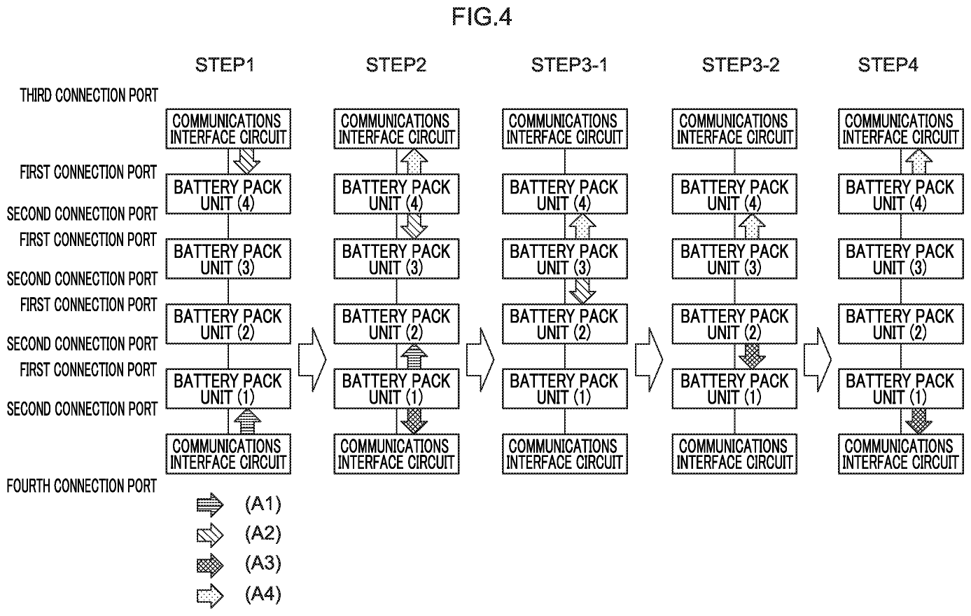

FIG. 4 is a diagram showing an example of a chronology of communications when the communications interface circuit 30 sends simultaneous requests and an output command is received from both directions at any of the battery pack units 20. In FIG. 4, the chronology of communications between the battery pack unit group 10 in which four of the battery pack units 20 are connected and the communications interface circuit 30 flows from step 1 to step 4. To facilitate description, the symbols (1) to (4) are appended to the four battery pack units 20 in the form “battery pack unit (N)”.

In FIG. 4, arrows (A1) to (A4) indicate flows of communication. Arrows (A1) and (A2) depict the output command, and arrows (A3) and (A4) depict the monitoring data (“communication data” below). Arrow (A1) depicts the monitoring data output command from the fourth connection port 31B of the communications interface circuit 30 (a first output command), and arrow (A2) depicts the monitoring data output command from the third connection port 31A of the communications interface circuit 30 (a second output command). Arrow (A3) depicts communication data, which is monitoring data, that is outputted in response to the monitoring data output command from the fourth connection port 31B of the communications interface circuit 30. Arrow (A4) depicts communication data, which is monitoring data, that is outputted in response to the monitoring data output command from the third connection port 31A of the communications interface circuit 30. To facilitate description, the group first connection port 11A and group second connection port 11B are not shown.

In step 1, the third connection port 31A and fourth connection port 31B of the communications interface circuit 30 simultaneously send the output command. The battery pack unit (1) receives the output command from the fourth connection port 31B at the second connection port 21B thereof, and the battery pack unit (4) receives the output command from the third connection port 31A at the first connection port 21A thereof. In step 2, the battery pack unit (1) outputs the output command (A1) through the first connection port 21A, and outputs communication data (A3) through the second connection port 21B. That is, the output command is outputted (A1) through the first connection port 21A of the battery pack unit (1) to the neighboring battery pack unit (2). The battery pack unit (4) outputs the output command (A2) through the second connection port 21B, and outputs communication data (A4) through the first connection port 21A. That is, the output command is outputted (A2) through the second connection port 21B of the battery pack unit (4) to the neighboring battery pack unit (3).

In step 3-1 and step 3-2, when the plural output commands are sent to a battery pack unit, arbitration processing is performed within the battery pack unit. This arbitration processing is different from the bus arbitration processing described above. In step 3-1, before the battery pack unit (2) would output the output command (A1), the battery pack unit (2) receives the output command (A2) from the battery pack unit (3). In this situation, the battery pack unit (2) outputs communication data (A3) through the second connection port 21B in response to the first output command (A1) through the second connection port 21B, as shown in step 3-2, and disregards, without processing, the output command (A2) that is received through the first connection port 21A after the output command (A1) has been received. In addition, the battery pack unit (2) does not output the output command (A1) from the second connection port 21B through the first connection port 21A. In step 4, the communication data from the battery pack unit (2) and the battery pack unit (3) is outputted to the communications interface circuit 30. In the present exemplary embodiment, the simultaneously sent requests are processed along the bidirectional path in this way, and the arbitration within battery pack units conducts control such that the requests are not propagated to collision. The communication data is outputted through the bidirectional connection ports, the group first connection port 11A and the group second connection port 11B, to the communications interface circuit 30.

The communication control as described above controls outputs of each of the plural battery pack units 20. When the output command is received first through the first connection port 21A of one battery pack unit 20, the one battery pack unit 20 outputs communication data through the first connection port 21A and sends the output command through the second connection port 21B to the first connection port 21A of a neighboring battery pack unit 20. The neighboring battery pack unit 20 outputs communication data through the first connection port 21A thereof, which is received through the second connection port 21B of the one battery pack unit 20. Hence, the communication data passes along the daisy-chain connection and is outputted from the group first connection port 11A.

When the output command is received first through the second connection port 21B of one battery pack unit 20, the one battery pack unit 20 outputs communication data through the second connection port 21B and sends the output command through the first connection port 21A to the second connection port 21B of a neighboring battery pack unit 20. The neighboring battery pack unit 20 outputs communication data through the second connection port 21B thereof, which is received through the first connection port 21A of the one battery pack unit 20. Hence, the communication data passes along the daisy-chain connection and is outputted from the group second connection port 11B.

When the output command is received through the first connection port 21A and then the output command is received through the second connection port 21B, the output command from the second connection port 21B is disregarded, in addition to which the output command from the first connection port 21A is not outputted through the second connection port 21B. When the output command is received through the second connection port 21B and then the output command is received through the first connection port 21A, the output command from the first connection port 21A is disregarded, in addition to which the output command from the second connection port 21B is not outputted through the first connection port 21A.

—Flow of Abnormality Detection—

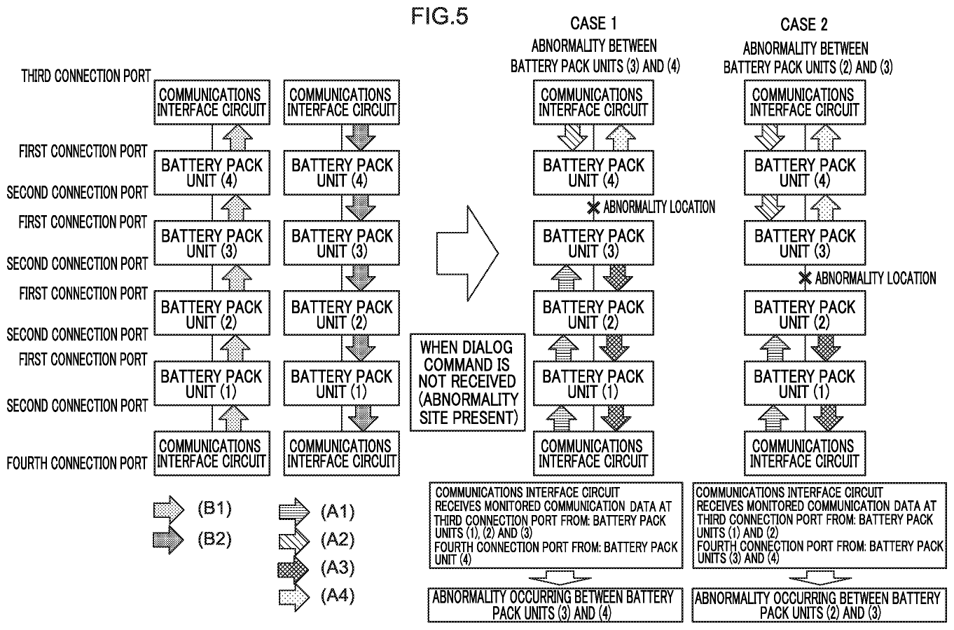

For abnormality detection in the battery monitoring system 1, communication path dialog commands are periodically sent to conduct abnormality detection and abnormality site detection. FIG. 5 is a diagram showing an example of using the communication path dialog commands for abnormality detection and abnormality site detection.

In FIG. 5, arrows (B1) and (B2) indicate flows of communication. The arrows (B1) and (B2) depict communication path dialog commands. Arrow (B1) depicts a communication path dialog command from the fourth connection port 31B of the communications interface circuit 30 (a first communication path dialog command), and arrow (B2) depicts a communication path dialog command from the third connection port 31A of the communications interface circuit 30 (a second communication path dialog command).

The communication path dialog command (B1) is sent from the fourth connection port 31B of the communications interface circuit 30, passes along the communication path of the battery pack units 20 of the battery pack unit group 10, and is received through the third connection port 31A. The communication path dialog command (B2) is sent from the third connection port 31A of the communications interface circuit 30, passes along the communication path of the battery pack units 20 of the battery pack unit group 10, and is received through the fourth connection port 31B. If one or both of the communication path dialog commands (B1) and (B2) is not received at the communications interface circuit 30, the battery management circuit 40 detects that there is an abnormality on the communication path.

When an abnormality on the communication path is detected, an abnormality site is detected by acquiring a collision site of an output command. As described for bus arbitration above, a monitoring data output command is simultaneously sent from the third connection port 31A and fourth connection port 31B of the communications interface circuit 30. Each of the battery pack units 20 receiving the output command outputs communication data that monitors which connection port of the communications interface circuit 30 the output command

is received from. That is, the communication data is information on which of the output commands (A1) and (A2) is processed as a request. A site between neighboring battery pack units 20 that receive the output command from the different connection ports is detected as being the abnormality site. In case 1 of FIG. 5, the battery pack units (1), (2) and (3) receive the output command (A1) from the fourth connection port 31B, and the battery pack unit (4) receives the output command (A2) from the third connection port 31A. In this case, the path between the battery pack unit (3) and the battery pack unit (4) is detected as the location of the abnormality. In case 2, the battery pack units (1) and (2) receive the output command (A1) from the fourth connection port 31B, and the battery pack units (3) and (4) receive the output command (A2) from the third connection port 31A. In this case, the path between the battery pack unit (2) and the battery pack unit (3) is detected as the location of the abnormality.

Bus arbitration communication control is conducted in the battery monitoring system 1 in accordance with the bus arbitration processing described above, enabling communications using paths in both directions of a daisy-chain connection at the same time.

—Supplementary Descriptions of the Bus Arbitration Timing Charts—

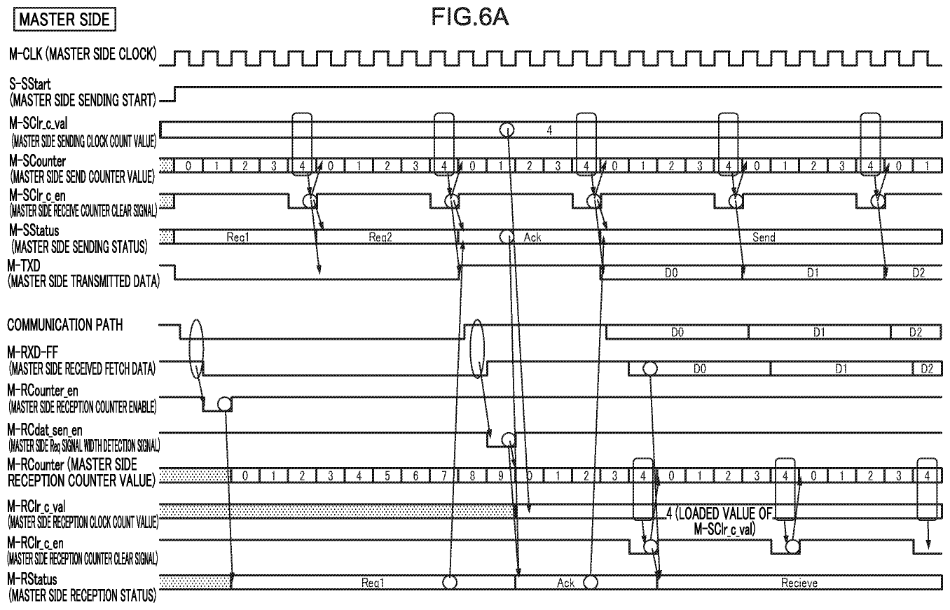

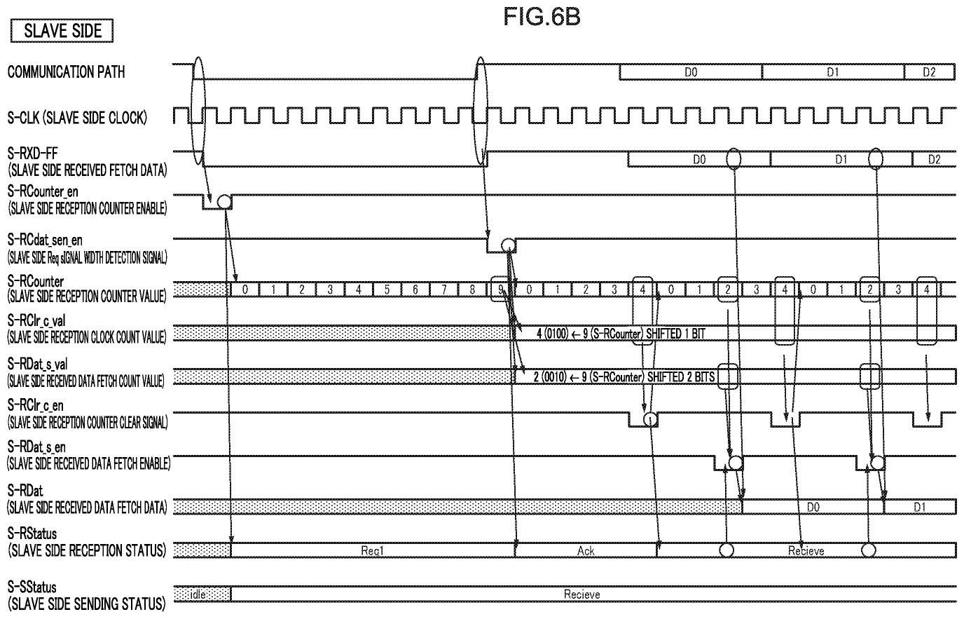

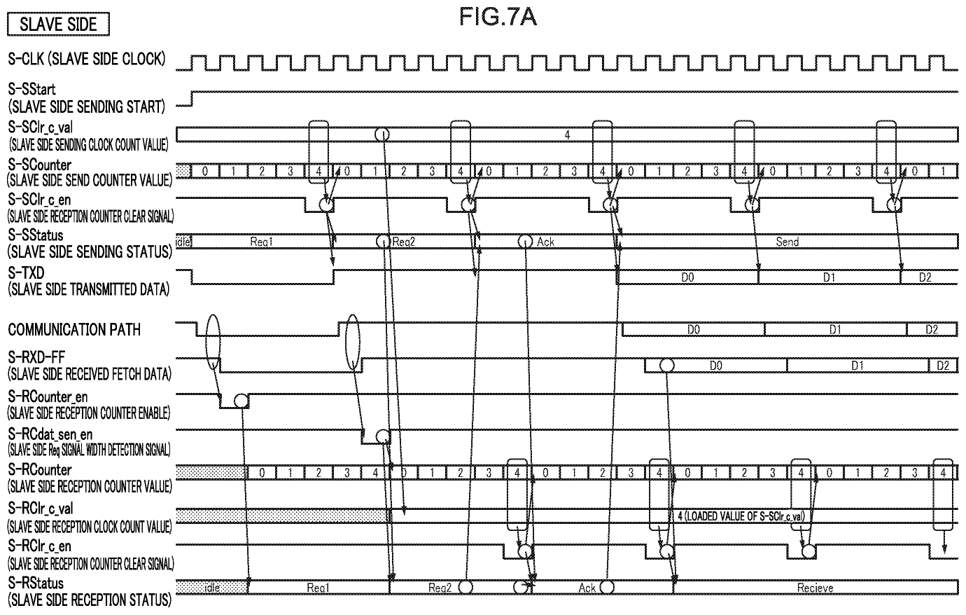

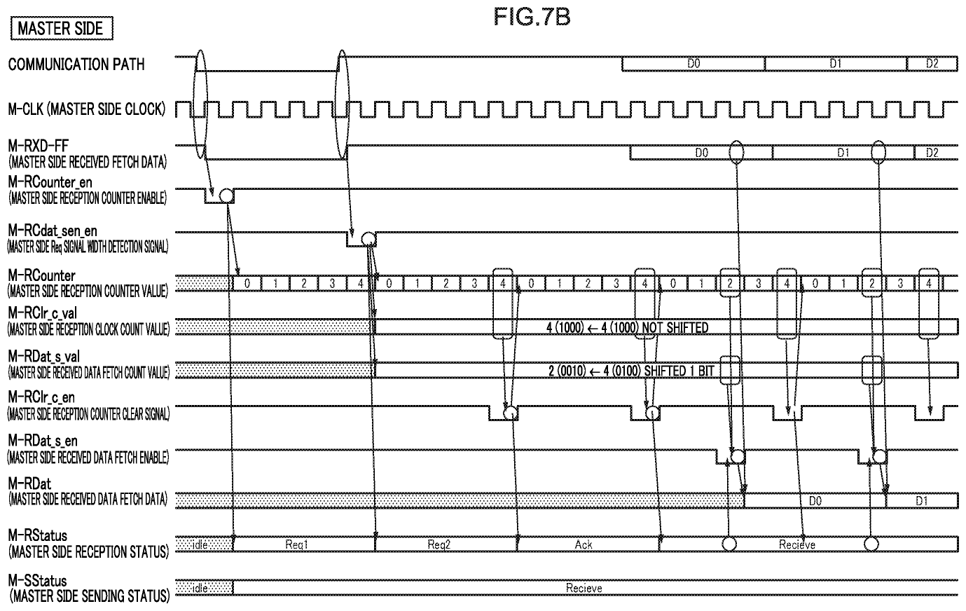

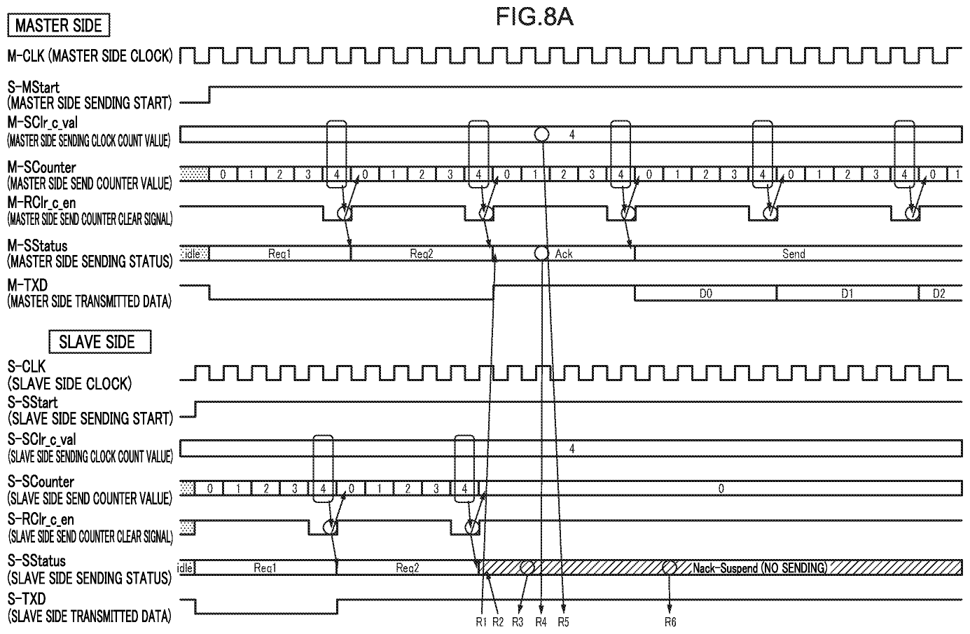

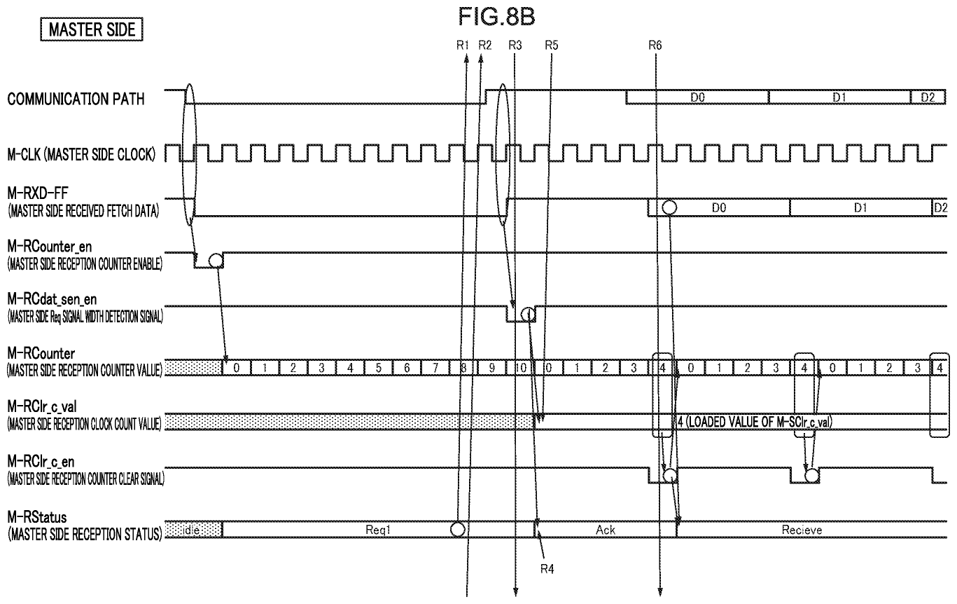

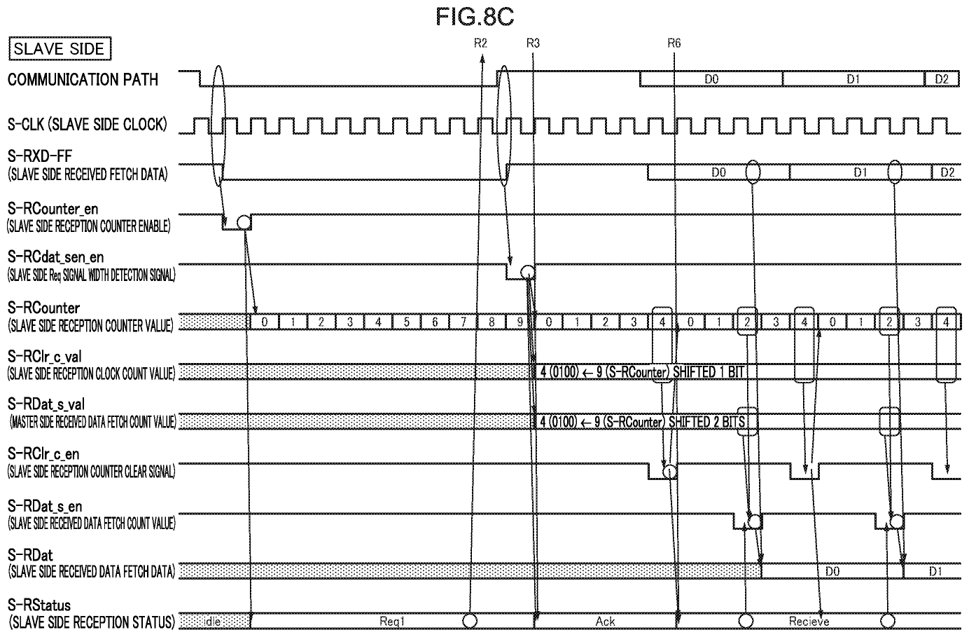

Details of the bus arbitration timing charts are described further. The respective timing charts relating to situations (A) to (C) shown in the above-described FIG. 3 are illustrated. FIG. 6A and FIG. 6B are timing charts of situation (A) in FIG. 3, the situation in which only the communication circuit 24 at the first connection port 21A sends a send request. FIG. 7A and FIG. 7B are timing charts of situation (B) in FIG. 3, the situation in which only the communication circuit 24 at the second connection port 21B sends a send request. FIG. 8A to FIG. 8C are timing charts of situation (C) in FIG. 3, the situation in which the communication circuits 24 at the first connection port 21A and the second connection port 21B both send a send request at the same time. The first connection port 21A is the master side and the second connection port 21B is the slave side.

For situation (A), FIG. 6A shows the master side and FIG. 6B shows the slave side. In this situation, the master is granted bus access and data is transferred from the master to the slave. In this situation, the received request is processed at the first connection port 21A. Accordingly, the reception status at the master side is “Req1”, the master side recognizes that no bus contention is occurring, and “M-SStatus” switches to “Ack”.

In order to process the request, respective communication control for the master and the slave is carried out at the connection port 21A. In communication control at the master side in situation (A), M-CLK (master side clock), S-MStart (master side sending start), M-SClr_c_val (master side sending clock count value), M-SCounter (master side send counter value), M-SClr_c_en (master side reception counter clear signal), M-SStatus (master side sending status) and M-TXD (master side transmitted data) are controlled. M-RXD-FF (master side received fetch data), M-RCounter_en (master side reception counter enable), M-RCdat_sen_en (master side Req signal width detection signal), M-RCounter (master side reception counter value), M-RClr_c_val (master side reception clock count value), M-RClr_c_en (master side reception counter clear signal), and M-RStatus (master side reception status) are also controlled.

In communication control at the slave side in situation (A), S-CLK (slave side clock), S-RXD-FF (slave side received fetch data), S-RCounter_en (slave side reception counter enable), S-RCdat_sen_en (slave side Req signal width detection signal), S-RCounter (slave side reception counter value), S-RClr_c_val (slave side reception clock count value), S-RDat_s_val (slave side received data fetch count value), S-RClr_c_en (slave side reception counter clear signal), S-RDat_s_en (slave side received data fetch enable), S-RDat (slave side received data fetch data), S-RStatus (slave side reception status) and S-SStatus (slave side sending status) are controlled. In situation (B), the situation in FIG. 7A and FIG. 7B in which the send request is made at the second connection port 21B, the master and slave are switched.

For situation (B), FIG. 7A shows the slave side and FIG. 7B shows the master side. In this situation, the slave is granted bus access and data is transferred from the slave to the master. In this situation, the received request is processed at the second connection port 21B. Accordingly, the reception status at the slave side is “Req2”, the slave side recognizes that no bus contention is occurring, and “S-SStatus” switches to “Ack”.

For situation (C), FIG. 8A shows the master side and the slave side, FIG. 8B shows the master side and FIG. 8C shows the slave side. In this situation, the master has bus access and data is transferred from the master to the slave. Arrows R1 to R6 cut across the timing charts. As shown at arrow R1, because the reception status at the slave side is not Req2, it is recognized that bus contention is occurring. When bus contention occurs, the master side and slave side already have the same information because of the simultaneous communication. However, the master side may not recognize the Req status of the slave side and the master side continues to send. Because the reception status at the slave side is not Req2, the slave side recognizes that bus contention is occurring and stops sending. As shown at arrow R6, the slave side is receiving data from the master side, but already has the same information because of the simultaneous communication and is attempting to send to the master side. Therefore, the slave side ultimately abandons received data. The slave side monitors a timing at which the bus is released. Note that when a Req signal from the slave side is outputted earlier than a Req signal from the master side, the master side may receive a Req signal on the communication path for longer than one cycle.

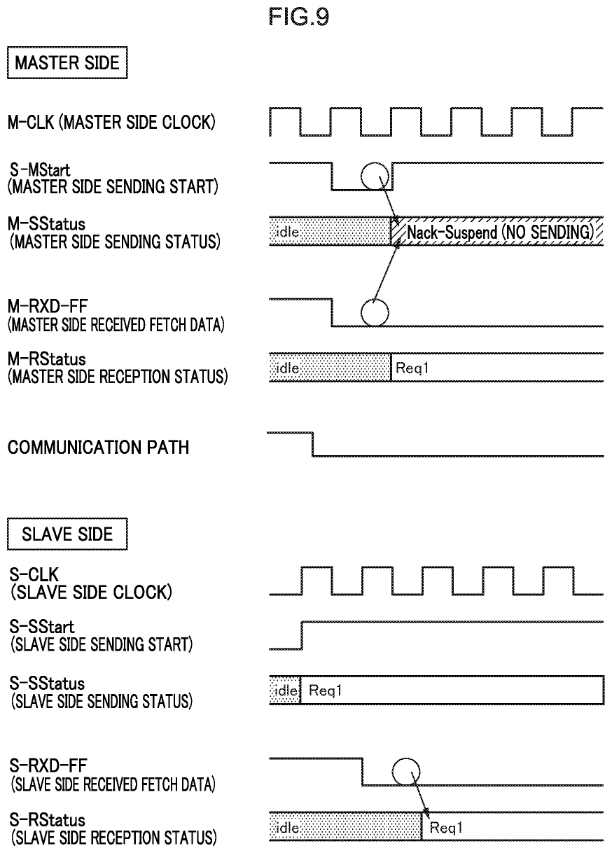

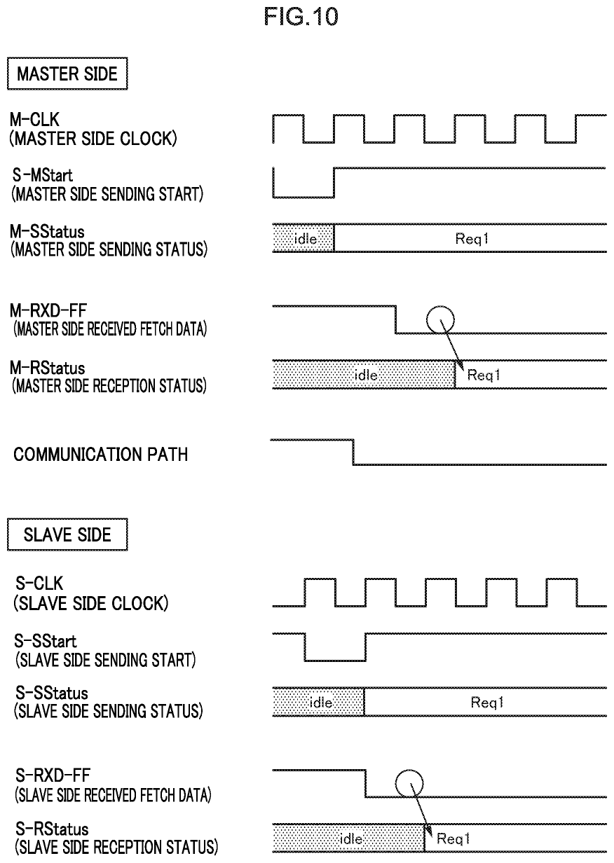

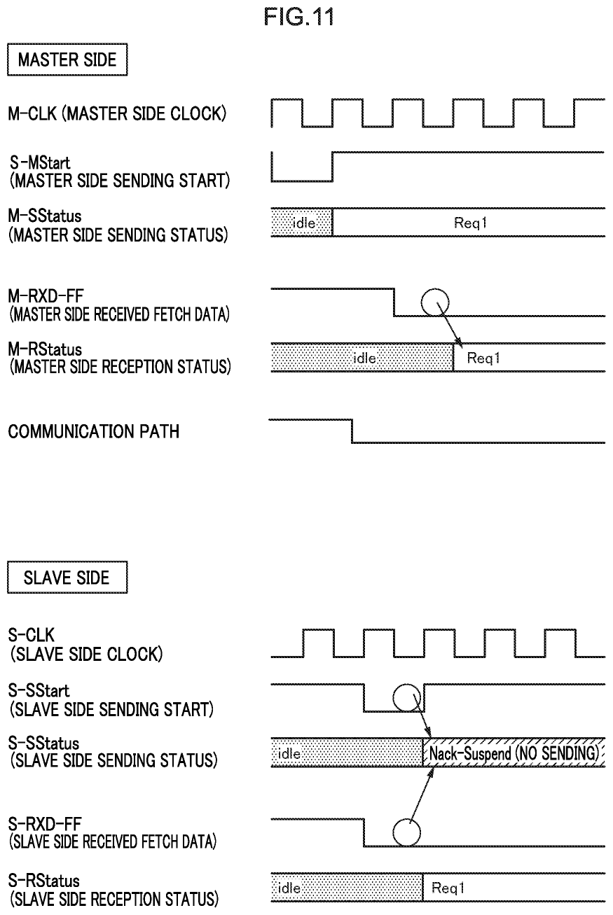

FIG. 9 shows a situation when the slave makes a Req request first and data is transferred from the slave to the master. FIG. 10 shows a situation when the master and slave make Req requests both at the same time, bus access is granted to the master, and data is transferred from the master to the slave (similarly to FIG. 8A to FIG. 8C). FIG. 11 shows a situation when the master makes a Req request first, bus access is granted to the master, and data is transferred from the master to the slave.

The present disclosure is not limited by the exemplary embodiment described above; numerous modifications and applications are possible within a scope not departing from the gist of the disclosure.

For example, the bus arbitration processing method described in the present exemplary embodiment is not limited to a battery monitoring system and may be applied to control methods of other buses in daisy-chain structures.

What is claimed is:

1. A bus control method for communication between a plurality of communication devices, the bus control method comprising:
a first communication device and a second communication device communicating via a bus structured with a first connection port and a second connection port;
the first communication device sending a first send request signal on the bus to the second communication device via the first connection port;
the second communication device sending a second send request signal on the bus to the first communication device via the second connection port; and
on the basis of the first send request signal and the second send request signal, performing control such that the bus accepts data from one connection port of the first connection port and the second connection port,
wherein the first send request signal and the second send request signal are respectively different signals.

2. The bus control method according to claim 1, further comprising:
when a send request signal is received, a communication section at the bus monitoring a state of the bus at a predetermined interval; and,
in accordance with a change in state of the bus in the predetermined interval, determining which of the communication devices the bus accepts a request from.

3. The bus control method according to claim 1, wherein the first send request signal and the second send request signal are signals with respectively different lengths.

4. The bus control method according to claim 3, wherein the first send request signal is longer than the second send request signal.

5. The bus control method according to claim 4, wherein the length of the first send request signal is the length of a predetermined interval, and the length of the second send request signal is half the length of the predetermined interval.
